(19) United States
(12) Patent Application Publication
(10) Pub. No.: US 2011/0240524 A1
(43) Pub. Date: Oct. 6, 2011

(54) METHOD AND APPARATUS FOR BREAKING AN EMULSION

(76) Inventor: Marcus Brian Mayhall Fenton, Cambridgeshire (GB)

(21) Appl. No.: 13/120,363

(22) PCT Filed: Oct. 8, 2009
(86) PCT No.: PCT/GB2009/051347

§ 371 Date: Jun. 10, 2011

(30) Foreign Application Priority Data
Oct. 8, 2008 (GB) 0818362.6

(51) Int. Cl. C10G 33/00; B01D 17/04

(52) U.S. Cl. 208/188; 210/150; 210/137; 210/151; 516/194; 516/196

(57) ABSTRACT

A method of demulsifying an emulsion is provided, the method comprising an initial step of supplying the emulsion to a fluid processor passage (14) having an inlet (16) and an outlet (18), wherein the cross sectional area of the passage (14) between the inlet (16) and outlet (18) does not reduce below the cross sectional area at the inlet (16). A transport fluid is supplied from a transport fluid source (60) to a transport fluid nozzle (34) which circumscribes the passage (14) and opens into the passage (14) intermediate the inlet (16) and the outlet (18). The transport fluid is accelerated through a throat (38) of the transport fluid nozzle (34), the throat (34) having a cross sectional area which is less than that of either the nozzle inlet (36) or nozzle outlet (40). The transport fluid is injected from the nozzle outlet (40) into the emulsion in the passage (14) such that the emulsion is atomised and a vapour-droplet regime is formed comprising a dispersed phase of emulsion droplets within a continuous vapour phase. At least some of the emulsion droplets are vaporised within the vapour-droplet regime and finally the vapour is condensed back to the liquid phase. An apparatus suitable for carrying out this method is also provided.

The present invention is concerned with the processing of fluids. More specifically, the present invention provides a process and apparatus for breaking emulsions.

An emulsion consists of two or more liquids, in which small droplets of one liquid (the dispersed phase) are dispersed throughout another liquid (the continuous phase). The stability of an emulsion is a function of a large number of parameters both of the bulk materials, such as density, viscosity, temperature, pH, ionic strength and droplet size, and of the interfacial film, such as film viscosity, electrical charge and surface tension. Emulsion stability is also affected by the nature, and quantity, of any emulsifying agents that might be naturally present or have been added. The means by which such agents stabilise an emulsion are many and varied. As an example, emulsifying agent surfactants for an oil-water emulsion have both an oil-soluble (hydrocarbon group) part and a water-soluble (polar) part. They therefore accumulate at the oil-water interface, whereby polar groups are directed towards the water, and hydrocarbon groups towards the oil, forming a stable interfacial skin. This skin resists the coalescence of emulsion droplets with like droplets and stabilises the emulsion. Likewise, powders such as fine particles of clay or sand can stabilise an emulsion by migrating to the interfacial film and forming a close-packed structure around the droplets that physically prevents coalescence.

Aqueous emulsions are commonly encountered in the petroleum industry where various techniques employed to retrieve crude oil from below ground can result in the creation of a water-in-oil or oil-in-water emulsion. An example of one such retrieval technique is steam-assisted gravity drainage, where oil trapped in sands is liquefied by having steam pumped through the sands. Although this technique allows the trapped oil to be removed from the sands, the resultant slurry arrives at the surface as a water and oil emulsion. It should be pointed out that the ‘oil’ in such crude oil is not a single homogenous material, but is composed of a mixture of different hydrocarbons, with different properties (density, viscosity, etc). Crude oil can therefore vary extensively between reservoirs. The formation of this emulsion and its stability thereafter can be aided by naturally occurring emulsifying agents contained in the oil such as naphthenic acids, resins and asphaltenes and impurities such as fine particles of clay or sand. Additionally, chemicals and agents used in the oil extraction process, such as drilling fluids, corrosion and scale inhibitors, wax and asphaltene dispersants and inhibitors can also contribute to the formation and stability of the emulsion. In order to recover the oil the emulsion needs to be broken in a process known as demulsification, and the water removed.

Crude oil is often found in reservoirs that naturally contain water and gas. In many instances this water is saline. Initially the oil and gas, which tend to be less dense, will be in the upper part of the reservoir, with the water below. As the oil and gas are extracted from the reservoir, water fills an increasingly large percentage of the reservoir and will eventually reach a point where it is being pumped to the surface along with the oil. The turbulence inherent in the pumping and extraction process and the possible presence of naturally occurring emulsifiers in the reservoir means that the mixture tends to arrive at the surface as an emulsion, often one with a large degree of salt also present. The emulsion must be broken prior to refining the oil, as water and other contaminants (in particular the salts) can damage pipelines and refinery equipment as well as lowering the crude oil's value. In some instances, even if there is little water present, there may still be large amounts of salts in the crude oil. Water may be added and mixed in to dissolve the salts, the emulsion so produced is then demulsified and the saline water removed, thereby purifying the crude oil.

Another extraction technique involves deliberately injecting water (e.g. sea water) into a reservoir as oil is removed from it. The water increases the pressure and/or displaces oil towards the extraction point, both processes that greatly increase the total amount of oil that can be recovered from a given reservoir and maintain the extraction rate for a longer period of time. This extraction technique can also result in an aqueous emulsion of crude oil arriving at the surface, which again needs separating into its constituent parts.

Another common process in the petroleum industry is to use oil-based fluids and muds to carry the drill cuttings out of the well. These cuttings must there-after be separated from the fluids/mud and, preferably, the fluids are then cleaned and re-used for cost and environmental reasons. Another large body of emulsions produced as a by-product of the extraction of crude oil is the so-called ‘waste oil’ that tends to be the hard to separate emulsions that traditionally would have been discarded or dumped in large storage tanks or lagoons. Changes in environmental regulations mean that the long-term environmental hazard posed by such deposits is no longer acceptable, and poses a significant cost for safe disposal. Furthermore, if the oil could be recovered from such ‘waste oil’ emulsions there would be a financial advantage to so doing.

In some instances highly viscous crude oil (e.g. bitumen and asphaltic crude) may need to be transported over distances through pipelines. Methods of achieving this include the use of diluents (e.g. a less viscous oil) or the use of heat to reduce viscosity. Such methods can be expensive, and an alternative is to create an emulsion by the deliberate addition of water and, possibly, an emulsifier, prior to transportation through the pipeline. Once at the destination, this emulsion also needs to be broken to remove the water and recover the oil.

In order to separate the oil from the water in the above examples, it is necessary to break the emulsion by disrupting, weakening or neutralising the forces and agents which promote stability within the emulsion and thus encourage coalescence of the dispersed liquid droplets with one another.

Conventional methods of breaking emulsions of this type very often rely on chemical demulsifying agents such as, for example, surfactants that counteract those naturally present in the crude oil (e.g. by neutralising charges that cause droplets to repel each other, or altering the behaviour of stabilising particles at the droplet surface) or agents that alter the pH or ion distribution in order to alter the emulsion chemistry, or promote aggregation (flocculation) and coalescence of the dispersed phase into larger droplets that can settle out of the continuous phase. For the agent to successfully disrupt the various forces that stabilise the emulsion it is added to the emulsion, which may then be heated to an elevated temperature in a separation vessel, whereupon the desired action can take place. Utilising large quantities of such agents can have a significant impact on the cost and environmental impact of the emulsion breaking process. Furthermore, heating the emulsion to a suitably high temperature and maintaining that temperature for many hours while the agents work to break the emulsion consumes a large amount of energy, which also adds to the cost and potential environmental impact of the process. Finally, filling, heating and draining a stand-alone separation vessel adds significantly to the time required to carry out the process.

As an example a field could be extracting 800,000 barrels (1 barrel=160 litres) of crude oil emulsion per day. If this is currently being dosed with demulsifier at the maximum dosing rate of 300 ppm in order to break the emulsion it means that 38,400 lt of demulsifier are required per day. At a cost of $4/lt of demulsifier this is a cost of $153,600 per day (plus the cost of heating the emulsion and holding it at an elevated temperature for some time) in order to break the emulsion and separate out the crude oil. Breaking the emulsion with little or no demulsifier could represent a significant cost saving over the operating life of the field.

U.S. Pat. No. 5,738,762 discloses an apparatus and method of separating the constituents of oil and water emulsions. The emulsion is heated, preferably by injecting steam into the emulsion, and then sprayed via a venturi nozzle into a flash fractionator vessel. The droplets of water and light oils present in the emulsion are flashed off to vapour in the vessel before being condensed and separated. The steam injection is performed using a conventional steam injector, which simply heats the emulsion. The spraying of the heated emulsion through the narrow throat of a venturi nozzle leaves the apparatus susceptible to blockage if particles are present in the emulsion.

It is an aim of the present invention to obviate or mitigate one or more of the aforementioned disadvantages.

According to a first aspect of the present invention, there is provided a demulsification apparatus comprising:
a fluid processor including a passage having an inlet and an outlet, and a transport fluid nozzle circumscribing the passage and opening into the passage intermediate the inlet and outlet; and
a transport fluid source in fluid communication with the transport fluid nozzle;
wherein the cross sectional area of the passage between the inlet and outlet does not reduce below the cross sectional area at the inlet; and
wherein the transport fluid nozzle is a convergent-divergent nozzle having a nozzle inlet, a nozzle throat, and a nozzle outlet, and the cross sectional area of the nozzle throat is less than that of either the nozzle inlet or nozzle outlet.

The demulsification apparatus may further comprise a holding vessel in fluid communication with the inlet of the fluid processor passage. A first control valve may control flow of emulsion from the holding vessel to the fluid processor.

The transport fluid source may be a steam generator. A second control valve may control flow of transport fluid from the transport fluid source to the transport fluid nozzle.

The apparatus may further comprise a pressure controller adapted to control the pressure of the transport fluid.

The fluid processor may further comprise an additive port in fluid communication with the passage. The additive port may be immediately downstream of the transport fluid nozzle outlet.

The apparatus may comprise a plurality of fluid processors connected to one another in series. Alternatively, the plurality of fluid processors may be connected to one another in series and/or parallel.

The apparatus may further comprise a separation vessel in fluid communication with the outlet of the fluid processor. The separation vessel may comprise a centrifuge.

The transport fluid nozzle may have an equivalent angle of expansion from the nozzle throat to nozzle outlet of between 8 and 30 degrees.

The fluid processor may include a housing and a protrusion which extends axially into the housing, whereby the protrusion defines a portion of the passage downstream of the passage inlet and an inner surface of the transport fluid nozzle outlet.

The passage has a longitudinal axis, and the inner surface of the transport fluid nozzle outlet may be at a maximum angle of 70 degrees relative to the longitudinal axis. Preferably, the inner surface of the transport fluid nozzle outlet is at a maximum of 35 degrees relative to the longitudinal axis.

The apparatus may further comprise a controller adapted to control the control valves.

The apparatus may further comprise a pump adapted to pump emulsion to the inlet of the fluid processor passage, wherein the controller also controls the pump.

The processor may further comprise a return loop and diverter valve downstream of the passage outlet, the return loop adapted to return fluid flow to the inlet of the passage.

The apparatus may further comprise upstream and downstream pressure regulating valves adapted to regulate the pressure within the apparatus.

According to a second aspect of the invention, there is provided a method of demulsifying an emulsion, the method comprising the steps of:
supplying the emulsion to a fluid processor passage having an inlet and an outlet, wherein the cross sectional area of the passage between the inlet and outlet does not reduce below the cross sectional area at the inlet;
supplying a transport fluid from a transport fluid source to a transport fluid nozzle which circumscribes the passage and opens into the passage intermediate the inlet and the outlet;
accelerating the transport fluid through a throat of the transport nozzle, the throat having a cross sectional area which is less than that of either a nozzle inlet or nozzle outlet;
injecting the transport fluid from the nozzle outlet into the emulsion in the passage such that the emulsion is atomised and a vapour-droplet regime is formed comprising a dispersed phase of emulsion droplets within a continuous vapour phase;
vaporising at least some of the emulsion droplets within the vapour-droplet regime; and
condensing the vapour back to the liquid phase.

The method may further comprise the step of separating the condensed constituents of the emulsion in a separation vessel.

The emulsion may be an aqueous emulsion. The term “aqueous emulsion” is used herein to describe an emulsion in which one of those liquids is water. The water may be in either the dispersed phase (water droplets in the other liquid) or the continuous phase (droplets of the other liquid in water). In some instances a stable multiple emulsion such as water-in-liquid-in-water may form. Water in this context is not limited to pure water, but instead is intended to encompass all types of water (e.g. salt water, hard and soft water, aqueous solutions).

The transport fluid may be a compressed gas. Preferably, the transport fluid source may be a steam generator and the transport fluid may be steam.

The emulsion may be an emulsion of water and crude oil. The steam generator may also supply steam to a steam-based crude oil extraction process.

The method may further comprise the step of adding a demulsifying agent to the emulsion. Preferably, the demulsifying agent is added to the emulsion via an additive port immediately downstream of the nozzle outlet in the passage.

The method may further comprise adding a diluent to the emulsion prior to supplying the emulsion to the fluid processor passage. Alternatively, the diluent may be added to the emulsion via an additive port in the passage immediately downstream of the transport fluid nozzle.

The method may further comprise adding a compressed gas to the emulsion upstream of the fluid processor.

The separation step may comprise gravitational separation. Alternatively, the separation step may comprise centrifugal separation.

A preferred embodiment of the present invention will now be described, by way of example only, with reference to the accompanying drawings, in which:

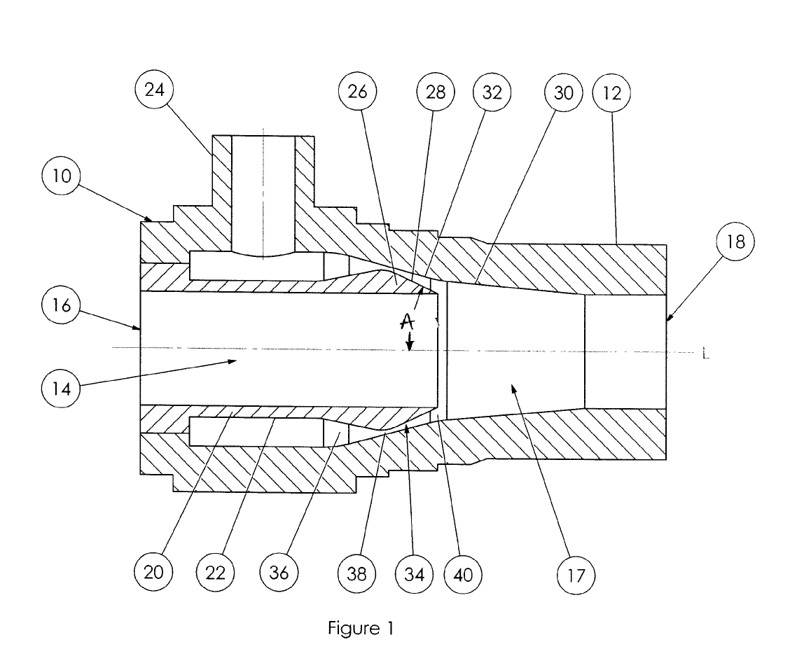

FIG. 1 is a cross sectional view of a fluid processor;

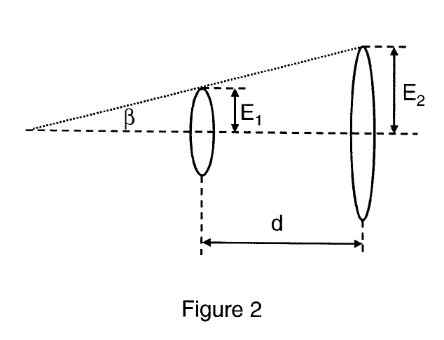

FIG. 2 is a diagram allowing the expansion angle of the transport fluid nozzle to be calculated; and

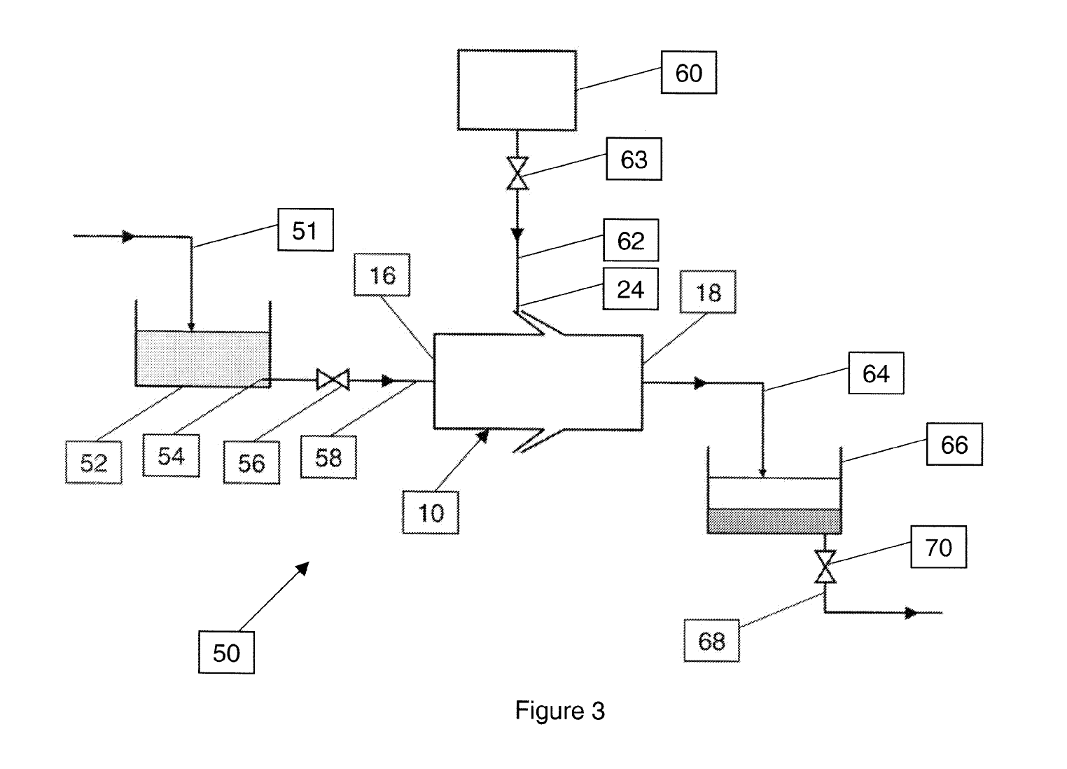

FIG. 3 is a schematic view of an apparatus for breaking an aqueous emulsion.

FIG. 1 is a vertical cross section through a fluid processor, generally designated 10. The processor 10 comprises a housing 12 within which is defined a longitudinally extending passage 14 with a longitudinal axis L.

The passage has an inlet 16 and an outlet 18 and is of substantially constant circular cross section. The cross sectional area of the passage 14 is never less than that of the inlet 16, so that any large particles that pass through the inlet 16 will meet with no constraining area reduction that prevents their motion through the rest of the passage 14.

A protrusion 20 extends axially into the housing 12 from the inlet 16 and defines exteriorly thereof a plenum 22 for the introduction of a compressible transport fluid. The plenum 22 is provided with an inlet 24 which is connectable to a source of transport fluid (not shown in FIG. 1). The protrusion 20 defines internally thereof the inlet 16 and an upstream portion of the passage 14. The protrusion 20 has a distal end 26 remote from the inlet 16. The distal end 26 of the protrusion 20 has a thickness which increases and then reduces again so as to define an inwardly tapering surface 28. The housing 12 has a wall 30, which at a location adjacent that of the tapering surface 28 of the protrusion 20 is increasing in thickness. This increase in thickness provides a portion of the wall 30 with a surface 32 which has an inward taper corresponding to that of the tapering surface 28 of the protrusion 20. Between them the tapering surface 28 of the protrusion 20 and the tapering surface 32 of the wall 30 define an annular nozzle 34. The nozzle 34 has a nozzle inlet 36 in flow communication with the plenum 22, a nozzle outlet 40 opening into the passage 14, and a nozzle throat 38 intermediate the nozzle inlet 36 and the nozzle outlet 40. The nozzle 34 is a convergent-divergent nozzle. As will be understood by the skilled reader, this type of nozzle has a nozzle throat 38 having a cross sectional area which is less than that of either the nozzle inlet 36 or the nozzle outlet 40. There is a smooth and continuous decrease in cross-sectional area from the nozzle inlet 36 to the nozzle throat 38 and a smooth and continuous increase in cross-sectional area from the nozzle throat 38 to the nozzle outlet 40. A convergent-divergent nozzle has no sudden step change or jump in cross-sectional area, though the surface might have a roughness, or small protuberances (vortex generators) to generate turbulence in the flow passing through the nozzle 34. The passage 14 also includes a mixing region 17, which is located in the passage immediately downstream of the nozzle outlet 40.

As an example the decrease and increase in the cross-sectional area of the nozzle 34 can be linear, or may have a more complex profile. One such profile might be that the stream-wise cross-section is substantially the same as that of a De Laval nozzle, which has a cross-section of an hour-glass-type shape. Given that the nozzle 34 is annular, ensuring that the cross-sectional area varies in the appropriate manner requires the calculation of an equivalent angle of expansion for the nozzle 34. FIG. 2 shows this schematically. E1 is the radius of a circle having the same cross sectional area as the nozzle throat 38. E2 is the radius of a circle having the same cross sectional area as the nozzle outlet 40. The distance d is the equivalent path distance between the throat 38 and the outlet 40. An angle β is calculated by drawing a line through the uppermost points of E2 and E1 which intersects a continuation of the equivalent distance line d. This angle β can either be measured from a scale drawing or else calculated from trigonometry using the radii E1, E2 and the distance d. The equivalent angle of expansion γ for the transport fluid nozzle can then be calculated by multiplying the angle β by a factor of two, where γ=2β. The optimal expansion in cross sectional area of the annular nozzle has been achieved using an equivalent angle of expansion in the range 8 to 30 degrees.

Referring back to FIG. 1, an angle A is defined between the inner surface 28 of the transport nozzle outlet 40 and the longitudinal axis L of the passage 14. The angle formed between the outer surface 32 of the nozzle outlet 40 and the longitudinal axis L is constrained by the required equivalent angle of expansion γ and hence the cross-sectional area of the nozzle outlet 40. The angle A is preferably between 0 and 70 degrees to the longitudinal axis L, and most preferably between 15 and 35 degrees to the longitudinal axis L.

The resulting nozzle 34 is a convergent-divergent nozzle as described above. The average flow velocity of the transport fluid at any given cross-section along such a nozzle depends on the flow conditions (temperature, pressure, density, phaseand, in the case of steam, on the dryness fraction) and on the cross-sectional area of the nozzle at that point. Under some flow conditions the transport fluid passing through such a nozzle 34 can be at subsonic velocities along its entire length, whilst at other flow conditions the fluid can undergo first subsonic and then supersonic flow as it passes along the nozzle length, up to and including fluid that is at supersonic velocities throughout the entire divergent portion of the nozzle and even downstream of the nozzle exit. Such flow conditions can be controlled by, for instance, a pressure controller at the transport fluid source or transport fluid nozzle inlet 24, or at some point between the two. As an example, a control valve (not shown) may be located immediately before the nozzle inlet 24. A pressure tapping may be located between the valve and the plenum 22 and linked to a pressure measuring device (not shown). An operator can adjust the valve such that it constricts transport fluid flow to a greater or lesser extent in order that the pressure in this region is maintained at a desired level or within a desired range. In a process plant, a remote controller is linked to the pressure measuring device such that the controller automatically opens or closes the valve so as to maintain the pressure at the predetermined level or within the desired range.

FIG. 3 shows schematically an apparatus for demulsification, or breaking an emulsion, which includes a fluid processor 10 of the type shown in FIG. 1. The apparatus 50 comprises a holding tank 52 which receives an aqueous emulsion (e.g. oil and water) from a remote location via a supply line 51. The holding tank 52 has an outlet 54 controlled by an outlet valve 56.

Downstream of the holding tank 52 is the fluid processor 10. The outlet 54 of the holding tank 52 is fluidly connected to the inlet 16 of the passage 14 shown in FIG. 1 via a first processing line 58. Also shown in FIG. 3 is a transport fluid supply 60, which is connected to the plenum inlet 24 of the processor 10 via a transport fluid supply line 62. A supply valve 63 controls flow of the transport fluid from the supply 60. Downstream of the processor 10 is a separation vessel 66 in which the components of the emulsion are separated from one another. The separation vessel 66 is fed via a second processing line 64 fluidly connected to the outlet 18 of the processor 10. The separation vessel 66 has a drain line 68 which is controlled by a drain valve 70.

If necessary, a pump (not shown) may be provided on the first processing line 58 to pump the emulsion from the holding tank 52 to the fluid processor 10. The various valves 56,63,70 in the apparatus, as well as the pump if present, may be controlled by a programmable system controller (not shown).

The process carried out by the apparatus 50 will now be described, with reference to both FIG. 1 and FIG. 3. Whilst the apparatus 50 is intended for use in breaking any aqueous emulsion, a preferred application of the apparatus 50 will be described here in which the apparatus is processing and breaking an oil and water emulsion. These oil and water emulsions are often the result of retrieval processes used in the oil industry for retrieving hard-to-extract oil deposits, such as where crude oil trapped in sand is retrieved by a steam-assisted gravity drainage process, for example.

Initially, the oil and water emulsion will be pumped to the surface from a well and then directed into the holding tank 52 via supply line 51. The emulsion can then be held in the tank 52 until processing is required. Where the emulsion is particularly viscous, a lighter oil or more water or heat may be added at this stage to aid handling of the emulsion through the apparatus.

When it is time to process the emulsion, the system controller (not shown) can open the outlet valve 56 in order to allow the emulsion to flow along the first processing line 58 into the processor 10. At the same time as the outlet valve 56 is being opened, the control apparatus also opens the supply valve 63 controlling the supply of transport fluid to the processor 10. Consequently, transport fluid flows from the transport fluid supply 60 into the processor 10 via the plenum 22. In this preferred embodiment, the transport fluid is a compressible gas which is heated in the transport fluid supply 60. The gas is preferably steam and the transport fluid supply 60 is preferably a steam generator. In steam-assisted gravity drainage applications the steam generator supplying the oil extraction process may be one and the same as that supplying steam to the processor 10 of the present invention, or the extraction and demulsification processes may have separate steam generators.

Referring to FIG. 1, the convergent divergent shape of the nozzle 34 accelerates the transport fluid and a high velocity, preferably supersonic, jet of transport fluid is injected into the fluid passage 14 from the nozzle outlet 40. At the same time, the emulsion is flowing through the inlet 16 of the passage 14. As the transport fluid is injected into the passage 14 from the nozzle 34 it imparts a shearing force on the emulsion as it passes the nozzle outlet 40. This shearing force atomises the emulsion, forming a flow made up of vapour and dispersed emulsion droplets which will hereinafter be referred to as a vapour-droplet regime. The injection of the high velocity transport fluid also creates an area of low pressure in the mixing region 17 of the passage 14 through which the vapour-droplet regime passes, thereby enhancing the vaporisation of any droplets of water or light oil fractions present. The differences in velocity, temperature and pressure between the transport fluid and the emulsion also leads to momentum transfer from the high velocity transport fluid to the lower velocity emulsion, causing the emulsion to accelerate. In addition, as the transport fluid flows from the reduced cross sectional area of the nozzle 34 into the comparatively large cross sectional area of the mixing region 17 the rapid change in the pressure and velocity of the transport fluid and the shear between it and the emulsion generates turbulence and vorticity. The turbulent mixing region 17 applies acceleration and deceleration forces on the droplets in the vapour-droplet regime, leading to a further atomisation of the droplets and increased likelihood of droplet collisions.

The angle A at which the transport fluid exits the nozzle 34 affects the degree of shear between it and the emulsion passing through the passage 14, the turbulence levels in the vapour-droplet flow regime and the further development of the fluid flow

As the vapour-droplet regime flows towards the outlet 18 of the passage 14 it will begin to decelerate. This deceleration will result in an increase in pressure within the passage 14. At a certain point within the passage 14, the decrease in velocity and rise in pressure will result in a rapid condensation of the vapour in the vapour-droplet regime. The point in the passage 14 at which this rapid condensation begins defines a condensation shockwave within the passage 14. A rise in pressure and consequent phase change takes place across the condensation shockwave, with the flow returning to the liquid phase on the downstream side of the shockwave. The position of the shockwave within the passage 14 is determined by the supply parameters (e.g. pressure, density, velocity, temperature) of the transport fluid and of the emulsion, the geometry of the fluid processor, and the rate of heat and mass transfer between the transport fluid and the emulsion.

The chemical and physical nature of aqueous emulsions varies widely. For instance, in the case of the petroleum industry, crude oil emulsions can vary not just between wells, but from the same well over time. The injection of the transport fluid into the passage 14 can have a number of effects on the emulsion. The injection of the high velocity transport fluid causes large amounts of turbulence, vorticity and shear in the mixing region 17 that atomise the emulsion, making droplet collisions more likely. The momentum transfer from the transport fluid to the emulsion causes the emulsion to accelerate. Emulsion droplets at high velocity in the mixing chamber and the condensation shockwave may therefore have sufficient energy (inertia etc) to overcome interfacial phenomena such as charge repulsion, aiding coalescence of like droplets.

The high levels of shear can also reduce the viscosity of the oil in the emulsion (so-called shear thinning) which can accelerate the gravity-assisted separation of the emulsion in the downstream separation vessel 66. Secondly, where the transport fluid is hotter than the emulsion (e.g. when the transport fluid is steam), heat transfer takes place between it and the emulsion. This heating reduces the surface tension of the droplets, making coalescence of like particles easier. Heat can also reduce the viscosity of the emulsion and destabilise or reduce the effect of the emulsifiers at the interfacial surface. The heat also encourages evaporation of the water and light portions of the oil contained within the emulsion, a process that is made easier by the greatly increased surface area of the atomised emulsion. The low pressure region created by the injection of the high velocity transport fluid also enhances the evaporation of the water and the light portions of the oil. Moreover, the vaporisation points and rates of the various light oil fractions in the emulsion and the water may be affected differently by the pressure drop and (where the transport fluid is hot) the addition of heat as they will have different specific latent heats of vaporisation.

The stabilising forces within the emulsion and the stability of the interfacial film are adversely affected by the physical disruption of the emulsion caused by the shear forces and turbulence generated by the transport fluid. If small particles (e.g. sand or clay) are present at the droplet surface, the disruptive processes described above may dislodge them, or introduce disorder into the structure they create about the droplets. Such effects also reduce the emulsion stability and encourage the droplets of the various liquids in the emulsion to coalesce with like droplets. In the vapour-droplet regime, droplets of water from the emulsion can coalesce with other water droplets or the condensing steam. A resultant cavitation process takes place within the mixing region 17 due to the vaporisation and subsequent rapid condensation of the water droplets (and possibly light oil fractions) in the emulsion. Cavitation has been shown in other applications to create temporary, localised high temperatures and pressures that can lead to localised beneficial effects such as breaking chemical bonds, generating free radicals and ions, altering pH, breaking up contaminants, causing high levels of shear, disrupting stabilising forces etc, phenomena that are also known to have beneficial effects in demulsification processes. Although such effects of cavitation are known to be short-lived and localised, the cumulative effect of large numbers of such cavitation processes is known to accelerate and improve various industrial processes. Such desirable effects can occur in the apparatus of the present invention.

The aforementioned mechanisms taking place in the fluid processor weaken or neutralise the forces stabilising the emulsion and/or the interfacial film between droplets of the liquids, thereby reducing the surface tension and encouraging the droplets of each liquid to separately coalesce with droplets of like type. The acceleration of the emulsion caused by the energy transfer from the transport fluid may aid the process of coalescence, by imparting sufficient momentum to the droplets that inertial effects overcome the interfacial phenomena such as repulsive charges that prevent droplets coalescing when they collide with each other. Thus, as the emulsion leaves the outlet 18 of the fluid processor 10, the droplets in the dispersed phase are coalescing together such that the emulsion has broken and is separating into its constituent parts.

The condensed liquids from the vapour-droplet regime leaving the outlet 18 of the fluid processor 10 are carried via the second processing line 64 to the separation vessel 66. The constituents of the emulsion can be left to complete their separation under gravity. The constituent liquid having the greatest density will fall to the bottom of the vessel 66. It can then be removed from the vessel 66 via the drain line 68 when the drain valve 70 is opened. The other liquids can thereafter be removed in turn via the same drain line 68. Water recovered from the separation vessel 66 can (possibly after some additional purification to remove water-soluble products) be heated up to make steam and re-used in the oil extraction/demulsification process or (where appropriate) be returned to the underground reservoir.

By atomising the aqueous emulsion to form a vapour-droplet flow regime in the manner described above, the process and apparatus of the present invention can destabilise the emulsion and/or the interfacial film between the dispersed and continuous phases which normally prevents droplets of the dispersed phase liquid from coalescing with one another. The heat transfer caused by the injection of certain transport fluids also assists with this disruption, as the heating of the emulsion reduces its viscosity and weakens the interfacial films of the dispersed phase liquid. The vapour-droplet flow regime created by the atomisation of the emulsion encourages coalescence of individual water droplets to one another and the steam, in instances where steam is being used as the transport fluid. The injection of the transport fluid that has a higher temperature than the emulsion causes heat transfer from the transport fluid to the emulsion. Additionally, the injection of the high velocity transport fluid into the emulsion creates a low pressure region. This means that the atomised water droplets and the light portions of the oil will vaporise at a lower temperature than if they were at atmospheric pressure.

It is believed that the process of the present invention may also disrupt the electrical charge which naturally causes each droplet to repel one another. This disruption is caused by one or more of the following effects: the cavitation caused by the vaporisation and subsequent rapid condensation of the water droplets immediately thereafter, a static charge build up due to the colliding droplets in the turbulent vapour-droplet phase, and the shear forces imparted by the transport fluid on the emulsion. Disrupting, and hence neutralising, the charge in this way allows the droplets to overcome their natural repulsion. It is also believed that the process of the present invention may cause transient, localised changes to the pH of the emulsion, which can also assist with this neutralisation of the charge between droplets. This change in pH may be a result of the release and possible re-absorption of carbon dioxide from the water as it is vaporised, or may be a result of gas being released from solution when passing through the low pressure region. Where steam is being used as the transport fluid, it may also result from carbon dioxide being trapped in the steam and carried from the steam generator.

Whilst the process and apparatus of the present invention provide an effective arrangement for breaking emulsions it may be beneficial in certain circumstances to add a demulsifying agent to the emulsion to assist in the break up. One such example is where an emulsifier has been added to help create the emulsion in the first instance (or where such an emulsifier occurs naturally in the oil, as previously described). In the present invention, the atomisation of the emulsion by the transport fluid to create a vapour-droplet regime exposes a large percentage of the surface area of the liquids to maximise the action of the demulsifying agent. Thus, the agent can be intimately mixed into the emulsion, thereby reducing the amount of agent required to break up the emulsion successfully.

Therefore, even if the process and apparatus of the present invention involve the use of a demulsifying agent they will be less expensive and less environmentally damaging than existing processes which use large quantities of such agents for breaking emulsions. Such demulsifying agents can also, in large quantities, promote corrosion in the pipeline, so, where they are necessary, minimising the amount required is a desirable outcome.

As the cross sectional area of the passage of the fluid processor does not reduce below that of its inlet, the apparatus has no restrictions in the flow path of the emulsion from the holding tank to the separation vessel. Thus, the apparatus is able to handle emulsions which include solids, as these solids will not block the apparatus once they are in the apparatus. Solid deposits can occur in water and oil emulsions when small particles (e.g. sand or grit) agglomerate in the emulsion. The disruption caused by the shearing force and turbulence caused by injection of the transport fluid into the processor may break up any such agglomerations of solid deposits present in the emulsion.

The apparatus can be installed into an existing processing line. It therefore does not need to operate as a stand alone process. The heating which occurs following the introduction of the steam or other suitable transport fluid removes the requirement for dedicated heating means to be employed in the process. By controlling the temperature of the transport fluid and/or the pressure at which it is introduced to the processor, the heat transfer between the transport fluid and emulsion can be optimised. The process and apparatus of the present invention is therefore able to consume less energy than typical emulsion-breaking processes and apparatuss which rely on inefficient stand-alone heated vessels. As the process of the present invention is continuous, it will also require less time to break the emulsion than such stand-alone arrangements.

Although a preferable feature of the apparatus, the holding tank is not essential. Instead, the inlet of the fluid processor may be directly connected to the source of emulsion.

Where the addition of a demulsifying agent is required, the agent may be added prior to the emulsion reaching the fluid processor. For example, it may be added to the holding tank (where present) or else in the first processing line upstream of the fluid processor. Alternatively, the processor may include an additive port which opens into the passage. The additive port may be located between the inlet and the nozzle, or it may alternatively open into the mixing region immediately downstream of the nozzle. The agent can then be entrained into the emulsion as it passes through the fluid processor. In a further alternative, the agent may also be added once the emulsion has left the outlet of the fluid processor, in order to supplement the process of breaking the emulsion that has already gone on within the fluid processor.

In a similar manner, a diluent may be added to the emulsion, so as to reduce its viscosity, or it may be necessary to add additional water to the emulsion to aid in the extraction of salts. The water that is added might not be pure water, but might be de-ionised, or, by addition of the appropriate chemicals, adjusted to have a given pH or salinity to aid in the demulsification process. These additional fluids may be added into the holding tank (where present) as previously described or else they may be added through an inlet into the first processing line upstream of the fluid processor. It may be necessary to add some form of mixing device into the pipeline upstream of the fluid processor inlet (or in the holding tank) to ensure that these additional fluids are intimately incorporated into the emulsion. Or it may be (particularly in the case of additional water for removal of salts) that the additional fluid can be added through the additive port directly into the mixing region immediately downstream of the transport nozzle, such that it will be readily entrained and mixed into the emulsion due to the high levels of turbulence, vorticity and shear in the mixing chamber of the fluid processor.

Whilst the apparatus preferably includes a separation vessel to complete the separation of the liquids once the emulsion has been broken, it is not essential for the apparatus or the process of breaking the emulsion itself. When present, the separation vessel preferably utilises gravity-assisted separation, but may optionally be provided with a centrifuge which will complete the separation of the liquids due to the centrifugal force generated in the centrifuge. The separation vessel may also include a number of drain lines and drain valves for draining the separated liquids to separate locations. In some embodiments of the present invention, the processor 10 may feed directly into the separation vessel 66, which is fluidly connected to the outlet 18 of the processor 10. The ejection of the broken emulsion into the separation vessel, where it goes from a small volume (the passage 14) to a large volume (the separation vessel 66), may occur in a manner that further aids in the separation of the constituent parts of the mixture. Additionally, any lighter more volatile portions of the oil that are contained in the mixture may rise more readily, particularly if they have remained in gaseous form, and could be separated off through an extra drainage pipe in the upper portion of the separation vessel. As either an alternative or in addition to the separation vessel, the apparatus may also comprise a secondary demulsifying device, such as an electrostatic coalescer or the like.

Where required, the process can be repeated to ensure successful breaking of the emulsion. To facilitate this, the processor may include a return loop and diverter valve which may selectively return the emulsion from the passage outlet back to the passage inlet instead of to the separation vessel or other downstream location. Alternatively, the repeating of the process steps may be achieved by adding an array of fluid processors to the apparatus. The array of fluid processors may comprise a plurality of processors in series, in parallel, or a combination of the two.

The apparatus may further comprise pressure regulating valves at the upstream and downstream ends of the apparatus for controlling pressure and temperature in the apparatus. These valves may be controlled by the system controller, where present. For some applications it may be desirable to have an entirely closed apparatus that can be held at a desired pressure above or below atmospheric. This might be the case, for instance, where volatile products are contained in the emulsion, and the aim is to prevent them from vaporising by holding the whole apparatus (or a part of the apparatus) at an elevated pressure. Another possible application might be where a compressed gas (such as carbon dioxide, nitrogen, argon or sulphur dioxide, for example) is injected into the emulsion in the upstream holding vessel under pressure and the mixture of gas bubbles and emulsion (or dissolved gas, depending on the flow conditions) remains under pressure until it reaches the fluid processor. At this point the drop in pressure caused by the injection of the transport fluid will cause the gas in the emulsion to undergo a rapid expansion. This could aid the atomisation of the emulsion and possibly alter the pH, with associated effects on emulsion stability.

The heating of the transport fluid is preferable, but not essential, to the process and apparatus of the present invention. As stated in the foregoing description, the compressible transport fluid is preferably steam. However, alternative transport fluids may be used. One such alternative is carbon dioxide, another is nitrogen. Where the compressible fluid is steam, the dryness fraction of the steam may be adjusted to give different performance conditions.

In some applications, the product to be processed may contain a mixture of oils that remain suspended in an emulsion, and those that separate out readily. In such an instance it may be suitable to turn the upstream holding tank into an upstream separation vessel, so that the oils which readily separate out may be removed prior to passing through the processor of the present invention, so as not to waste energy and time on processing products that do not need such treatment. Likewise a mixture might readily separate into an oil phase, a water phase and an emulsion phase, or the mixture might be one where some of the solids present will naturally settle out. Again, such easily recoverable fractions/ contaminants could be removed from the holding tank/ upstream separation vessel prior to treating the emulsion.

The above described demulsifying apparatus and process may be of use in areas other than the (petroleum) oil extraction/refining industry; industries where oil-water emulsions also need separating. Examples might include dealing with oil-contaminated waste water, so as to meet legislative and environmental requirements concerning water treatment, and there may also be a commercial benefit to separating out some oils so that they can be re-used. A couple of non-limiting examples of such sources of oil-contaminated waste water includes: by-products from heavy industry and manufacturing and the cleaning out of ships tanks and bilges.

Oil-water emulsions may also need to be separated in the production of, for instance, oil extracted from biological (animal or vegetable) sources non-limiting examples of which are fish oil and palm oil. Such oil is then processed and can be used for fuel, food, or its beneficial properties. Alternatively, potentially useful compounds produced by such biological sources may be contained in, for example, a fibrous portion of a plant. Oil and/or water from an external source may be deliberately added to aid in the extraction of such compounds, and the emulsion so produced would then need to be broken. Alternatively, the oil and water naturally present in the plant may be all that is required. Such compounds can have useful properties (e.g. pharmaceutical, nutritional, medicinal). Examples of such useful compounds are the pigments lycopene and beta-carotene that are produced by some plants and are highly soluble in oil.

The above mentioned oils are originally of biological origin, however the apparatus and process of the present invention may also be of use in fields where it is necessary to separate synthetic oil-water emulsions. It should also be obvious that, even as crude oil contains a large number of different types of oil, the biological/synthetic emulsions discussed above need not consist of oil from a single source, but could consist of a mixture of oils from various sources (e.g. where several plants are processed together to extract their oil, producing an oil-water emulsion).

The preferred embodiments of the apparatus and process describe breaking an aqueous emulsion, but it should be understood that the present invention may be used to break any emulsion comprising two or more liquids. Whilst ideally suited for this process, the invention is not limited to the breaking of aqueous emulsions.

These and other modifications and improvements may be incorporated without departing from the scope of the present invention.

What is claimed is:

1. A demulsification apparatus comprising:
a fluid processor including a passage having an inlet and an outlet, and a transport fluid nozzle circumscribing the passage and opening into the passage intermediate the inlet and outlet; and
a transport fluid source in fluid communication with the transport fluid nozzle;
wherein the cross sectional area of the passage between the inlet and outlet does not reduce below the cross sectional area at the inlet; and
wherein the transport fluid nozzle is a convergent-divergent nozzle having a nozzle inlet, a nozzle throat, and a nozzle outlet, and the cross sectional area of the nozzle throat is less than that of either the nozzle inlet or nozzle outlet.

2. The apparatus according to claim 1, further comprising a holding vessel in fluid communication with the inlet of the fluid processor passage.

3. The apparatus according to claim 1, wherein the transport fluid source is a steam generator.

4. The apparatus according to claim 1, further comprising a pressure controller adapted to control the pressure of the transport fluid.

5. The apparatus according to claim 1, wherein the fluid processor further comprises an additive port in fluid communication with the passage, the port being located immediately downstream of the transport fluid nozzle outlet.

6. The apparatus according to claim 1, comprising a plurality of fluid processors connected to one another in series and/or parallel.

7. The apparatus according to claim 1, further comprising a separation vessel in fluid communication with the outlet of the fluid processor.

8. The apparatus according to claim 7, wherein the separation vessel comprises a centrifuge.

9. The apparatus according to claim 1, wherein the transport fluid nozzle has an equivalent angle of expansion from the nozzle throat to nozzle outlet of between 8 and 30 degrees.

10. The apparatus according to claim 1, wherein the fluid processor includes a housing and a protrusion which extends axially into the housing, whereby the protrusion defines a portion of the passage downstream of the passage inlet and an inner surface of the transport fluid nozzle outlet; and wherein the passage has a longitudinal axis, and the inner surface of the transport fluid nozzle outlet is at a maximum angle of 70 degrees relative to the longitudinal axis.

11. The apparatus according to claim 10, wherein the inner surface of the transport fluid nozzle outlet is at a maximum angle of 35 degrees relative to the longitudinal axis.

12. The apparatus according to claim 1, wherein the processor further comprises a return loop and diverter valve downstream of the passage outlet, the return loop adapted to return fluid flow to the inlet of the passage.

13. The apparatus according to claim 1, further comprising upstream and downstream pressure regulating valves adapted to regulate the pressure within the apparatus.

14. A method of demulsifying an emulsion, the method comprising the steps of:
supplying the emulsion to a fluid processor passage having an inlet and an outlet, wherein the cross sectional area of the passage between the inlet and outlet does not reduce below the cross sectional area at the inlet;
supplying a transport fluid from a transport fluid source to a transport fluid nozzle which circumscribes the passage and opens into the passage intermediate the inlet and the outlet;
accelerating the transport fluid through a throat of the transport nozzle, the throat having a cross sectional area which is less than that of either a nozzle inlet or nozzle outlet;
injecting the transport fluid from the nozzle outlet into the emulsion in the passage such that the emulsion is atomised and a vapour-droplet regime is formed comprising a dispersed phase of emulsion droplets within a continuous vapour phase;
vaporising at least some of the emulsion droplets within the vapour-droplet regime; and
condensing the vapour back to the liquid phase.

15. The method according to claim 14, further comprising the step of separating the condensed constituents of the emulsion in a separation vessel.

16. The method according to claim 14, wherein the transport fluid is a compressed gas.

17. The method according to claim 14, wherein the transport fluid source is a steam generator and the transport fluid is steam.

18. The method according to claim 17, wherein the emulsion is an emulsion of water and crude oil.

19. The method according to claim 18, wherein the steam generator may also supply steam to a steam-based crude oil extraction process.

20. The method according to claim 14, further comprising the step of adding a demulsifying agent to the emulsion via an additive port immediately downstream of the nozzle outlet in the passage.

21. The method according to claim 14, further comprising the step of adding a diluent to the emulsion prior to supplying the emulsion to the fluid processor passage.

22. The method according to claim 14, further comprising the step of adding a diluent to the emulsion via an additive port in the passage immediately downstream of the transport fluid nozzle.

23. The method according to claim 14, further comprising adding a compressed gas to the emulsion upstream of the fluid processor.
